(19) United States
(12) Patent Application Publication
(10) Pub. No.: US 2012/0169465 A1
(43) Pub. Date: Jul. 5, 2012

(54) Vehicle Apparatus Control System and Method Thereof

(75) Inventors: Wen-Yan Chang, Hsinchu (TW); Tai-Chang Yang, Kaohsiung City (TW); Yu-Chen Huang, Zhudong Township (TW)

(73) Assignee: ALTEK CORPORATION, Hsinchu (TW)

(21) Appl. No.: 13/150,544

(22) Filed: Jun. 1, 2011

(30) Foreign Application Priority Data
Dec. 31, 2010 (TW) 099147418

(51) Int. Cl. G06F 7/04

(52) U.S. Cl. 340/5.83

(57) ABSTRACT

A vehicle apparatus control system is used to control at least one piece of vehicle equipment in a vehicle, and includes a data storage module, an image capture module, a face recognition module, and a control module. The data storage module stores a plurality of facial expression parameters therein. The face recognition module detects a face image from an image captured by the image capture module and determines a facial expression in the face image based on the facial expression parameters. The control module controls the vehicle equipment to enter into a first state based on the facial expression. When the facial expression is recognized as a sleeping facial expression, the control module controls the vehicle seat to move into a horizontal position and mutes a vehicle stereo. A vehicle apparatus control method for controlling at least one piece of vehicle equipment in a vehicle is also disclosed.

### FIELD OF THE INVENTION

The present invention relates to a vehicle apparatus control system and a method, and more particularly to a vehicle apparatus control system and a method that is able to control at least one piece of vehicle equipment in a vehicle based on an identity or a facial expression of a user taking the vehicle.

### BACKGROUND OF THE INVENTION

Currently, a smart central control setting system is a type of very common equipment for cars, and also a main advertising appeal to consumers in promoting sale of high-rank cars. However, the operation menus for various functions provided by the currently available vehicle central control systems have not yet reached the level allowing for customization. That is, all the users have to share the same central control settings for the vehicle equipment provided in their vehicles. Further, the currently available smart central control setting systems still require users to manually make settings by operating a plurality of push keys to therefore cause inconvenience to the users.

While the face recognition technique has been widely employed in the fields of camera control and identity verification, it has not been widely applied to the vehicle field.

### SUMMARY OF THE INVENTION

A primary object of the present invention is to provide a vehicle apparatus control system and method, so that a range of vehicle equipment provided in a vehicle is more conveniently controllable for a user to use the vehicle in a more comfortable manner.

To achieve the above and other objects, the vehicle apparatus control system according to the present invention for controlling at least one piece of vehicle equipment in a vehicle includes a data storage module, an image capture module, a face recognition module, and a control module. The data storage module stores at least one facial expression parameter therein, and the image capture module captures an image. The face recognition module detects a face image from the captured image and determines a facial expression contained in the detected face image based on the facial expression parameter; and the control module controls the vehicle equipment to enter into a first state based on the facial expression.

Preferably, the data storage module further stores a facial characteristic parameter and a vehicle equipment setting parameter for at least one user, and the face recognition module recognizes a user to whom the face image corresponds based on the facial characteristic parameter, and the control module control the vehicle equipment to enter into a second state according to the vehicle equipment setting parameter corresponding to the recognized user.

In the present invention, the facial expression includes one of a sleeping facial expression and a non-sleeping facial expression.

In the present invention, the vehicle equipment includes at least one of a vehicle seat, a visual/audio (AV) device, an illumination device, an air-conditioner, and a network access device.

According to the present invention, the control module generates a driver notice message when the face recognition module recognizes the facial expression is the sleeping facial expression.

To achieve the above and other objects, the vehicle apparatus control method according to the present invention for controlling at least one piece of vehicle equipment in a vehicle includes the following steps: providing at least one facial expression parameter; capturing a face image of a user in the vehicle; recognizing a facial expression contained in the face image based on the facial expression parameter; and controlling the vehicle equipment to enter into a first state based on the facial expression.

Preferably, the vehicle apparatus control method further includes the following steps: providing a facial characteristic parameter and a vehicle equipment setting parameter for at least one user; and recognizing the user to whom the face image corresponds based on the facial characteristic parameter, and controlling the vehicle equipment to enter into a second state based on the vehicle equipment setting parameter corresponding to the recognized user.

In the vehicle apparatus control method of the present invention, the facial expression includes one of a sleeping facial expression and a non-sleeping facial expression.

In the vehicle apparatus control method of the present invention, the vehicle equipment includes at least one of a vehicle seat, a visual/audio (AV) device, an illumination device, an air-conditioner, and a network access device.

According to the method of the present invention, the control module generates a driver notice message when the face recognition module recognizes the facial expression is the sleeping facial expression.

To achieve the above and other objects, the vehicle apparatus control system for controlling at least one piece of vehicle equipment in a vehicle comprises: a data storage module storing at least one facial expression parameter, a facial characteristic parameter and a vehicle equipment setting parameter for at least one user; means for capturing an image; means for detecting a face image from the captured image; means for recognizing the user to whom the face image corresponds based on the facial characteristic parameter; means for determining a facial expression contained in the detected face image based on the facial expression parameter; and means for controlling the vehicle equipment based on the facial expression and the vehicle equipment setting parameter corresponding to the recognized user.

In the present invention, the facial expression includes one of a sleeping facial expression and a non-sleeping facial expression.

In the present invention, the vehicle equipment includes at least one of a vehicle seat, a visual/audio (AV) device, an illumination device, an air-conditioner, and a network access device.

In the present invention, the vehicle apparatus control system comprises means for generating a driver notice message when the recognized facial expression is the sleeping facial expression.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of the vehicle apparatus control system according to the present invention in a first embodiment thereof;

FIG. 2 is a block diagram of the vehicle apparatus control system according to the present invention in a second embodiment thereof;

FIG. 3 is a flowchart showing the steps included in the vehicle apparatus control method according to the present invention in a first embodiment thereof; and

FIG. 4 is a flowchart showing the steps included in the vehicle apparatus control method according to the present invention in a second embodiment thereof.

### DETAILED DESCRIPTION OF THE PREFERRED EMBODIMENTS

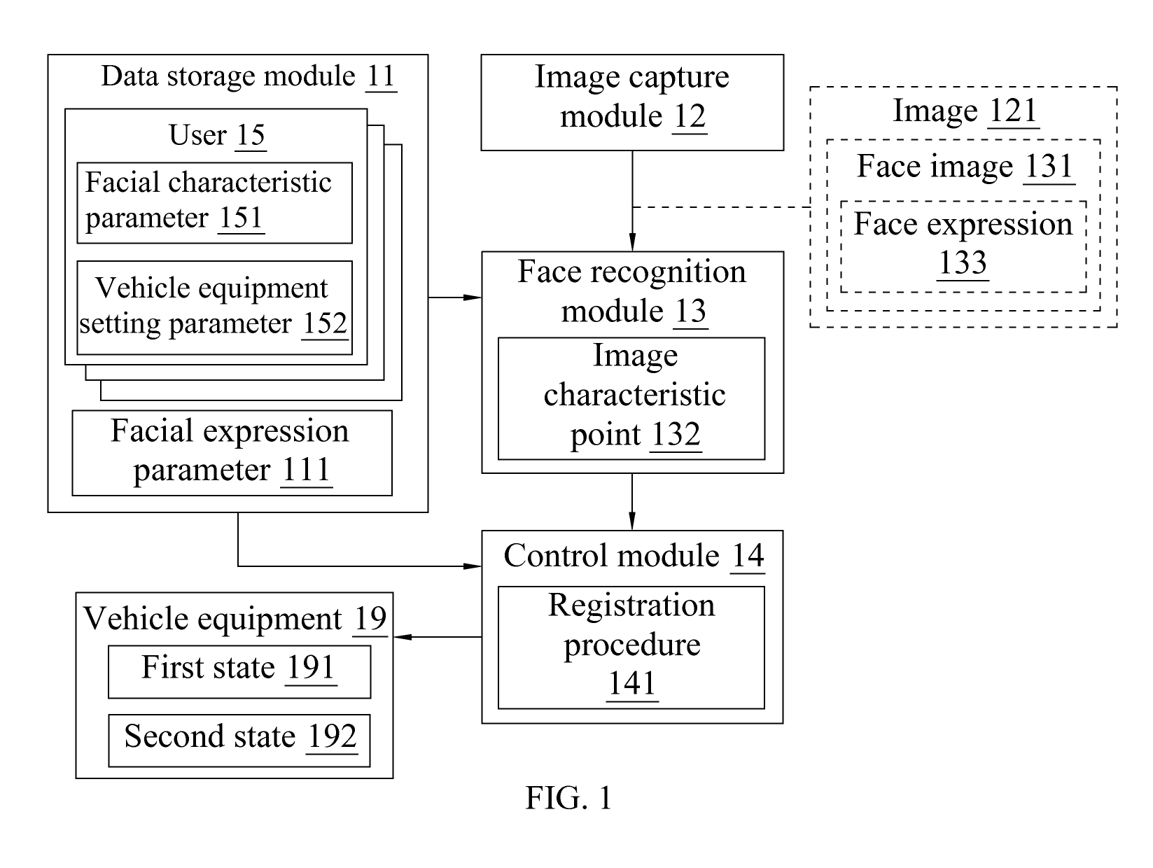

Please refer to FIG. 1 that is a block diagram of the vehicle apparatus control system according to the present invention in a first embodiment thereof. As shown, the vehicle apparatus control system in the first embodiment thereof is used to control at least one piece of vehicle equipment 19 in a vehicle, and includes a data storage module 11, an image capture module 12, a face recognition module 13, and a control module 14. In the data storage module 11, there are stored at least one facial expression parameter 111 as well as a facial characteristic parameter 151 and a vehicle equipment setting parameter 152 for each of a plurality of users 15 who have been registered on the vehicle apparatus control system. In implementing the present invention, the data storage module 11 can be a hard disk, an optical storage medium, a flash memory, or other non-volatile memory. The image capture module 12 serves to capture an image 121. In implementing the present invention, the image capture module 12 is preferably an image sensor, such as a charge-coupled device (CCD) or a complementary metal-oxide-semiconductor (CMOS) device. One or more image capture modules 12 can be provided depending on actual need. In implementing the present invention, it is possible to provide only one image capture module 12 capable of capturing images of all seats in the vehicle or to provide one image capture module 12 for each of the seats in the vehicle to capture the image of a corresponding seat.

The face recognition module 13 serves to detect a face image 131 from the image 121 captured by the image capture module 12, extract an image characteristic point 132 from the face image 131, compare the image characteristic point 132 with the facial expression parameter 111, and determine a facial expression 133 contained in the face image 131 according to a result from the comparison. Since the technical means in connection with the above-mentioned facial expression parameter, the facial characteristic parameter, the image characteristic point extraction and the facial expression recognition are known among persons skilled in the art, they are not discussed in details herein. The above-mentioned facial expression may be a sleeping facial expression or a non-sleeping facial expression. In implementing the present invention, the sleeping facial expression can be determined by finding out whether a user closes eyes while facing forward for a long time or whether a user tilts his or her head sidewardly for a long time. If yes, it is determined the user is resting or sleeping.

The control module 14 controls the vehicle equipment 19 to enter into a first state 191 according to the user's facial expression 133. In the present invention, the control module 14 is preferably a microprocessor or a vehicle computer, and the vehicle equipment 19 may include a vehicle seat, an audio/visual (AV) device, an illumination device, an air-conditioner, or a network access device. The face recognition module 13 can also compare the image characteristic point 132 of the face image 131 with the facial characteristic parameters 151 and use comparison result to recognize a user 15 to whom the face image 131 corresponds, so that the control module 14 can, based on the vehicle equipment setting parameter 152 corresponding to the user 15, control the vehicle equipment 19 to enter into a second state 192. It is noted the sequence for the vehicle equipment 19 to enter into the first state 191 or the second state 192 is not necessarily the same as that described above, which is only an example to enable easy description of the present invention.

For example, when a user 15 is sitting on a vehicle seat and is recognized by the face recognition module 13, the control module 14 can set the seat to a user favorite state according to the vehicle equipment setting parameter 152 set and stored by the user 15, and the user favorite state is also the second state 192 of the above-mentioned vehicle seat. And, when the user 15 closes eyes to take a rest and the face recognition module 13 recognizes the user's facial expression as a sleeping facial expression, the control module 14 will set the vehicle seat to a somewhat horizontal position by lowering seat back and lifting the user's legs, so that the user 15 can take a rest in a more comfortable manner. At this point, the vehicle seat is in the above-mentioned first state 191.

Besides, all those skilled in the art may randomly combine the functional modules into an integrated means or divide them into each detailed functional means, depending on the convenience of design.

The facial characteristic parameter 151 for each of the users having been registered on the vehicle apparatus control system can be a built-in data. In addition, when the face recognition module 13 detects the image 121 captured by the image capture module 12 includes a user who is not registered on the system, the control module 14 will perform a registration procedure 141 to set the image characteristic point 132 as the new user's facial characteristic parameter 151 and store the same in the data storage module 11. And then, the new user is considered as a registered user. The above-mentioned registration procedure 141 may be automatically performed by the vehicle apparatus control system or manually performed by the user.

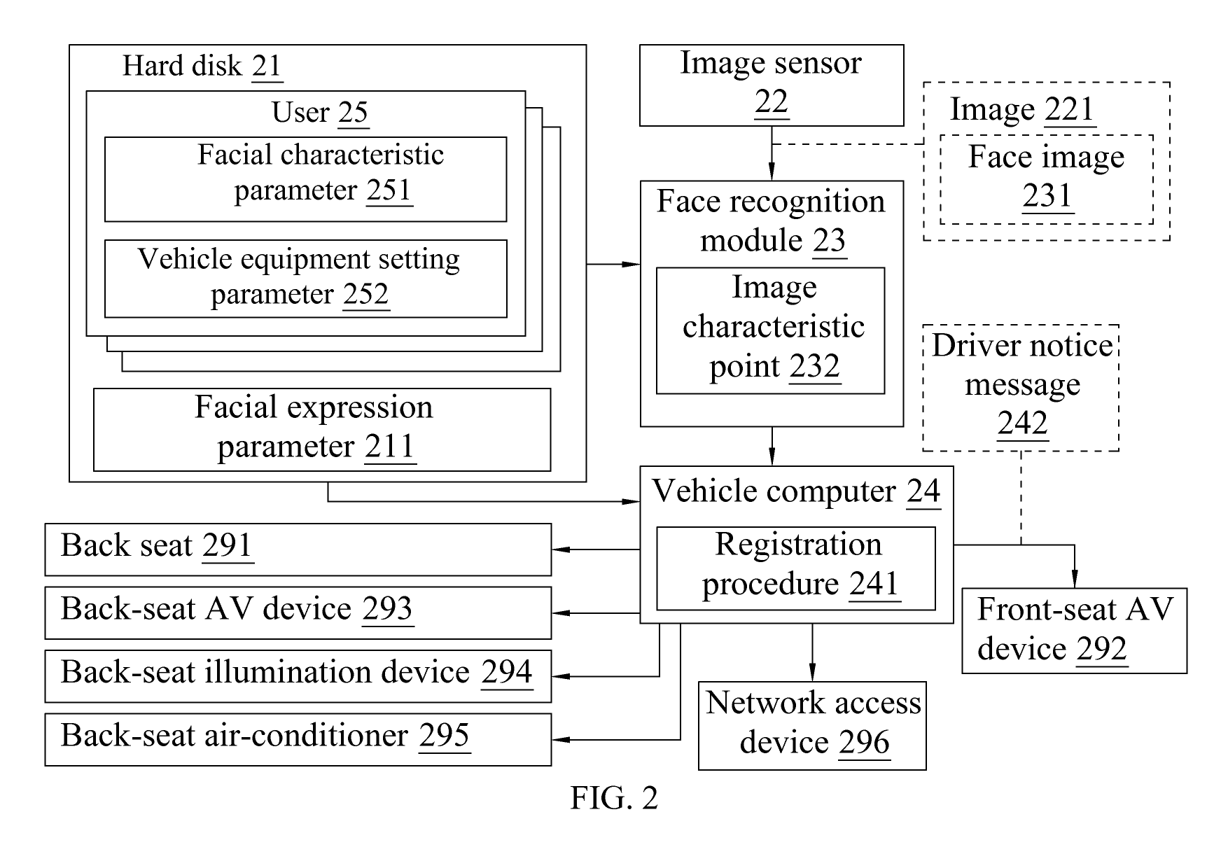

Please refer to FIG. 2 that is a block diagram of the vehicle apparatus control system of the present invention in a second embodiment thereof. As shown, the vehicle apparatus control system in the second embodiment thereof is used to control a back seat 291, a front-seat AV device 292, a back-seat AV device 293, a back-seat illumination device 294, a back-seat air-conditioner 295 and a network access device 296; and is applicable to a vehicle that internally includes two independent spaces, i.e. a front driving space and a back seat space separated from each other, and a driver of the vehicle can not directly see the state in the back seat space. The vehicle apparatus control system in the second embodiment thereof includes a hard disk 21, an image sensor 22, a face recognition module 23, a vehicle computer 24, and a door sensor (not shown). In the hard disk 21, there are stored a plurality of facial expression parameters 211 as well as a facial characteristic parameter 251 and a vehicle equipment setting parameter 252 for each of a plurality of users 25 who have been registered on the vehicle apparatus control system. The vehicle equipment setting parameter 252 may include the user's favorite settings for the back seat 291, the back-seat AV device 293, the back-seat illumination device 294, the back-seat air-conditioner 295 and the network access device 296.

When the door sensor detects the car door is legally opened, the vehicle computer 24 controls the back-seat illumination device 294 to actuate and emit light, so that the user 25 can clearly see the current state in the back seat space in the vehicle. After the user has sit on the back seat 291, the image sensor 22 captures an image 221, which is then recognized by the face recognition module 23 based on the facial characteristic parameters 251 stored in the hard disk 21 in order to recognize the user 25. Thereafter, the vehicle computer 24 can, based on the vehicle equipment setting parameter 252 stored in the hard disk 21 and corresponding to the recognized user 25, set the back seat 291 into the user's favorite position, set the back-seat AV device 293 to play the user's favorite AV contents at the user's favorite volume and display the user's favorite program menu, set the back-seat illumination device 294 to the user's favorite brightness, and set the back-seat air-conditioner 295 to the user's favorite temperature.

Then, the image sensor 22 keeps capturing images 221, and the face recognition module 23 also keeps recognizing the captured images 221 to find out whether the user 25 closes eyes while facing forward for a long time or tilts his or her head sidewardly for a long time, in order to determine whether the user's facial expression is a sleeping facial expression or a non-sleeping facial expression. If it is recognized that the user 25 is in a sleeping facial expression, the vehicle computer 24 would then control the back seat 291 to a somewhat horizontal position suitable for the user 25 to sleep, control the back-seat AV device 293 to a low volume, to mute, or to turn off, control the back-seat illumination device 294 to dim or to turn off, and control the back-seat air-conditioner 295 to a properly lowered temperature. In the illustrated second embodiment, since the driver is not able to see the state in the back seat space, the vehicle computer 24 would generate a driver notice message 242 and display the same on the front-seat AV device 292 when the face recognition module 23 recognizes the user 25 is in a sleeping facial expression. As a result, the driver is reminded by image, sound or vibration that the user 25 in the back seat space is sleeping now, and timely changes to a different driving manner to possibly reduce the vibration during driving and allowing the user 25 to sleep or take a rest in the vehicle in a more comfortable manner. In addition, when the face recognition module 23 recognizes the user's facial expression changes from the sleeping facial expression to the non-sleeping facial expression, the vehicle computer 24 can also generate another corresponding driver notice message 242 and transmit the same to the front-seat AV device 292 for informing the driver of such change.

Further, the user 25 can use the network access device 296 to connect to a network, such as Internet, to browse web pages or to receive or send emails. When the face recognition module 23 recognizes that the user 25 is in a sleeping facial expression, the vehicle computer 24 is able to control the network access device 296 to stop receiving or sending emails or to send a mail reception stopped message to senders who send emails to the user 25.

When the face recognition module 23 recognizes that the user 25 changes from the sleeping facial expression to the non-sleeping facial expression, the vehicle computer 24 would then set the back seat 291, the back-seat AV device 293, the back-seat illumination device 294 and the back-seat air-conditioner 295 again based on the user's vehicle equipment setting parameter 252 stored in the hard disk 21.

The facial characteristic parameter 251 for each of the users 25 having been registered on the vehicle apparatus control system can be a built-in data. In addition, when the face recognition module 23 detects the image 221 captured by the image capture module 22 includes a user who is not registered on the system, the vehicle computer 24 will perform a registration procedure 241 to set an image characteristic point 232 as the new user's facial characteristic parameter 251 and store the same in the hard disk 21. And then, the new user is considered as a registered user. The above-mentioned registration procedure 241 may be automatically performed by the vehicle apparatus control system or manually performed by the user.

With the above arrangements, the vehicle apparatus control system of the present invention is able to provide smart control for a user sitting on the back seat to feel more comfortable.

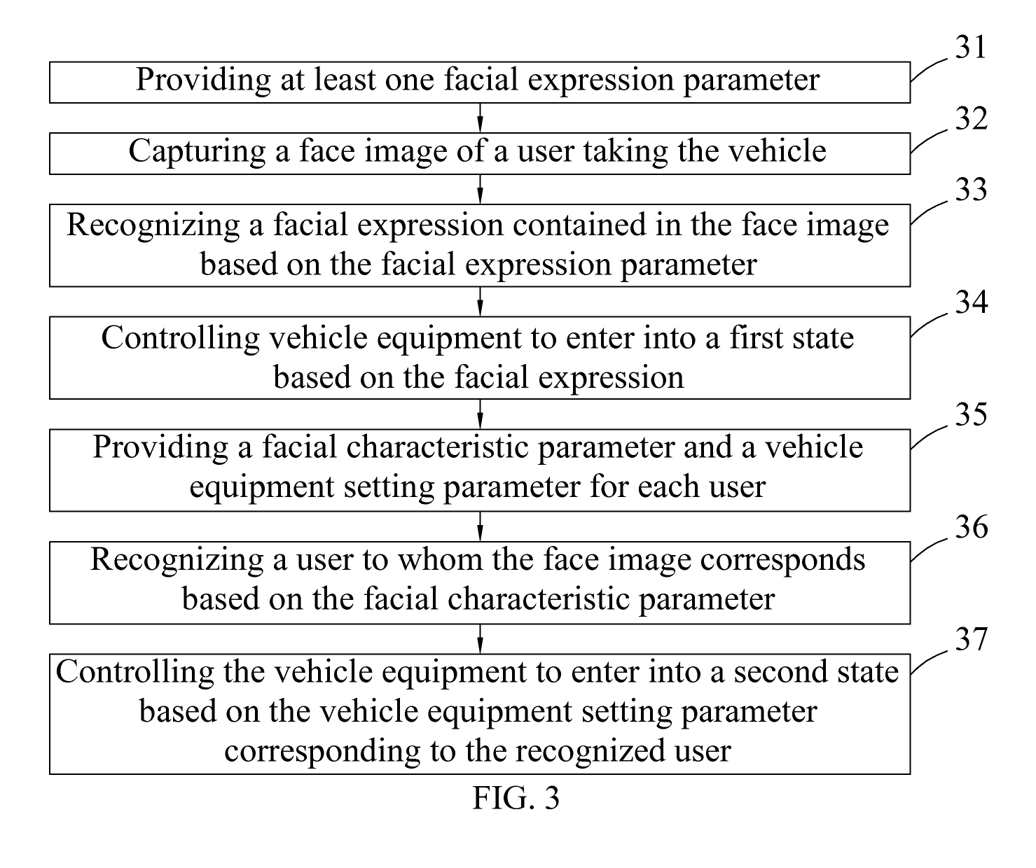

FIG. 3 is a flowchart showing the steps included in a vehicle apparatus control method according to the present invention in a first embodiment thereof. The vehicle apparatus control method is applicable for controlling at least one piece of vehicle equipment in a vehicle, such as a seat, an AV device, an illumination device, an air-conditioner, or a network access device. Please refer to the vehicle apparatus control method shown in FIG. 3. In a step 31, at least one facial expression parameter is provided. In a step 32, a face image of a user in the vehicle is captured. In implementing the present invention, it is possible to provide only one image capture module capable of capturing images of all seats in the vehicle or to provide one image capture module for each of the seats in the vehicle to capture the image of a corresponding seat. The image capture module is preferably an image sensor, such as a CCD or a CMOS device.

In a step 33, a facial expression contained in the captured face image is recognized based on the facial expression parameter. Preferably, the facial expression includes one of a sleeping facial expression and a non-sleeping facial expression. In implementing the present invention, the sleeping facial expression can be determined by finding out whether a user closes eyes while facing forward for a long time or whether a user tilts his or her head sidewardly for a long time. If yes, it is determined the user is resting or sleeping. In a step 34, the vehicle equipment is controlled based on the recognized facial expression to enter into a first state.

In a step 35, a facial characteristic parameter and a vehicle equipment setting parameter for at least one user are provided. In a step 36, a user to whom the face image corresponds is recognized based on the facial characteristic parameter. In a step 37, the vehicle equipment is controlled to enter into a second state based on the vehicle equipment setting parameter corresponding to the recognized user. Wherein, the facial expression parameter, the facial characteristic parameter and the vehicle equipment setting parameter can be stored in a hard disk, an optical storage medium, a flash memory or other non-volatile memory installed on the vehicle.

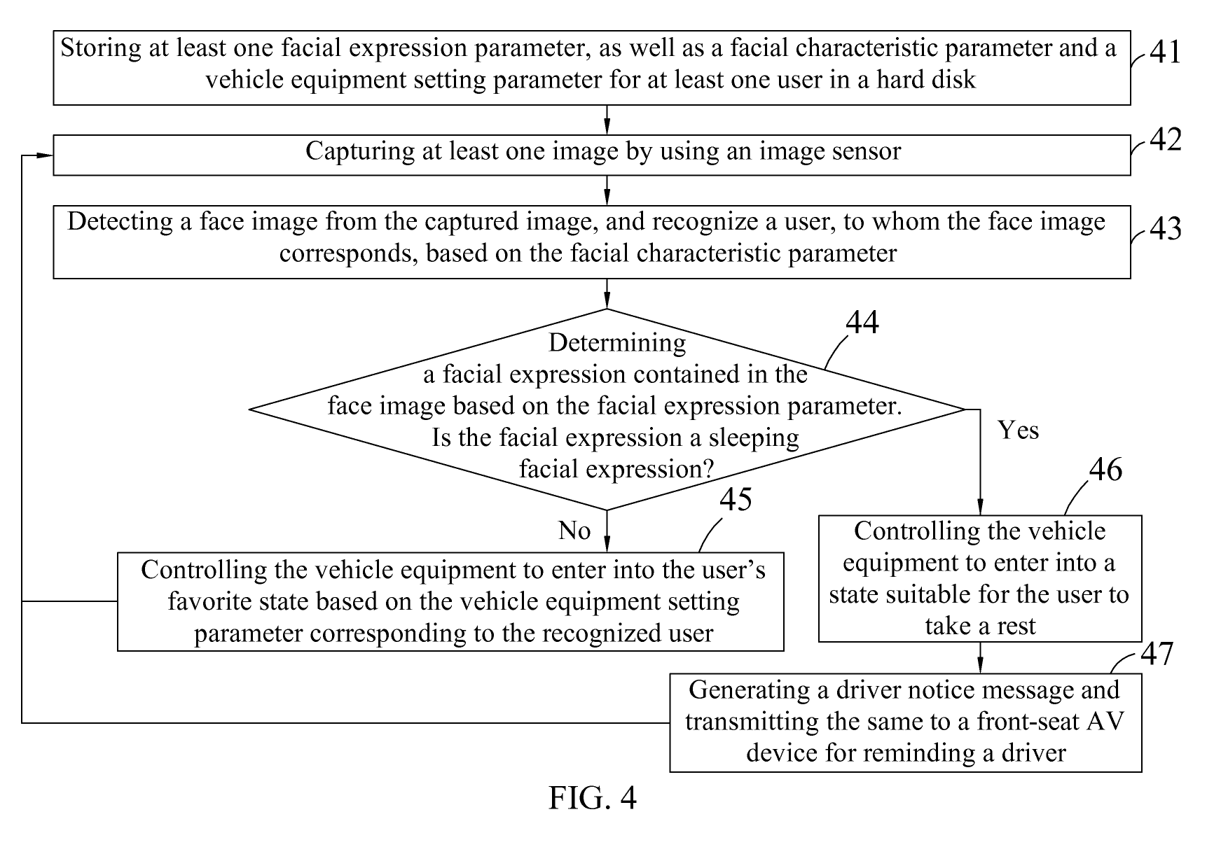

Please refer to FIG. 4 that is a flowchart showing the steps included in the vehicle apparatus control method according to the present invention in a second embodiment thereof. As shown, in a step 41, a plurality of facial expression parameters, as well as a facial characteristic parameter and a vehicle equipment setting parameter for each of a plurality of users who have been registered on the vehicle apparatus control system are stored in a hard disk installed in a vehicle. In a step 42, at least one image is captured by using an image sensor. In a step 43, a face image in the captured image is detected, and a user, to whom the face image corresponds, is recognized based on the facial characteristic parameter. In a step 44, the facial expression parameters are used as a basis to determine whether a facial expression contained in the facial image is a sleeping facial expression. If not, it means the user is in a waking state, and a step 45 is performed; or if yes, a step 46 is performed.

In the step 45, the vehicle equipment setting parameter corresponding to the recognized user is used as a basis to control the vehicle equipment to enter into the user's favorite state, and then the method goes back to the step 42.

In the step 46, the vehicle equipment is controlled to enter into a state suitable for the user to take a rest, such as controlling a back seat to a somewhat horizontal position suitable for the user to lie down and sleep, controlling a back-seat AV device to a low volume, to mute or to turn off, controlling a back-seat illumination device to dim or to turn off, controlling a back-seat air-conditioner to a properly lowered temperature, etc. In a step 47, a driver notice message is generated and transmitted to a front-seat AV device for displaying, so as to remind a driver by image, sound or vibration. Thereafter, the method goes back to the step 42.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A vehicle apparatus control system for controlling at least one piece of vehicle equipment in a vehicle, comprising:
a data storage module storing at least one facial expression parameter therein;
an image capture module capturing an image;
a face recognition module detecting a face image from the captured image and determining a facial expression contained in the detected face image based on the facial expression parameter; and
a control module controlling the vehicle equipment to enter into a first state based on the facial expression.

2. The vehicle apparatus control system as claimed in claim 1, wherein the data storage module further stores a facial characteristic parameter and a vehicle equipment setting parameter for at least one user, wherein the face recognition module recognizes the user to whom the face image corresponds based on the facial characteristic parameter, and wherein the control module controls the vehicle equipment to enter into a second state according to the vehicle equipment setting parameter corresponding to the recognized user.

3. The vehicle apparatus control system as claimed in claim 1, wherein the facial expression includes one of a sleeping facial expression and a non-sleeping facial expression.

4. The vehicle apparatus control system as claimed in claim 1, wherein the vehicle equipment includes at least one of a vehicle seat, a visual/audio (AV) device, an illumination device, an air-conditioner, and a network access device.

5. The vehicle apparatus control system as claimed in claim 3, wherein the control module generates a driver notice message when the face recognition module recognizes the facial expression is the sleeping facial expression.

6. A vehicle apparatus control method for controlling at least one piece of vehicle equipment in a vehicle, comprising the following steps:
providing at least one facial expression parameter;
capturing a face image of a user in the vehicle;
recognizing a facial expression contained in the face image based on the facial expression parameter; and
controlling the vehicle equipment to enter into a first state based on the facial expression.

7. The vehicle apparatus control method as claimed in claim 6, further comprising the following steps:
providing a facial characteristic parameter and a vehicle equipment setting parameter for at least one user; and
recognizing the user to whom the face image corresponds based on the facial characteristic parameter, and controlling the vehicle equipment to enter into a second state based on the vehicle equipment setting parameter corresponding to the recognized user.

8. The vehicle apparatus control method as claimed in claim 6, wherein the facial expression includes one of a sleeping facial expression and a non-sleeping facial expression.

9. The vehicle apparatus control method as claimed in claim 6, wherein the vehicle equipment includes at least one of a vehicle seat, a visual/audio (AV) device, an illumination device, an air-conditioner, and a network access device.

10. The vehicle apparatus control method as claimed in claim 8, further comprising the step of generating a driver notice message to a driver when the facial expression is recognized as the sleeping facial expression.

11. A vehicle apparatus control system for controlling at least one piece of vehicle equipment in a vehicle, comprising:
a data storage module storing at least one facial expression parameter, a facial characteristic parameter and a vehicle equipment setting parameter for at least one user;
means for capturing an image;
means for detecting a face image from the captured image;
means for recognizing the user to whom the face image corresponds based on the facial characteristic parameter;
means for determining a facial expression contained in the detected face image based on the facial expression parameter; and
means for controlling the vehicle equipment based on the facial expression and the vehicle equipment setting parameter corresponding to the recognized user.

12. The vehicle apparatus control system as claimed in claim 11, wherein the facial expression includes one of a sleeping facial expression and a non-sleeping facial expression.

13. The vehicle apparatus control system as claimed in claim 11, wherein the vehicle equipment includes at least one of a vehicle seat, a visual/audio (AV) device, an illumination device, an air-conditioner, and a network access device.

14. The vehicle apparatus control system as claimed in claim 12, wherein the vehicle apparatus control system comprises means for generating a driver notice message when the recognized facial expression is the sleeping facial expression.
